(19) United States
(12) Patent Application Publication
(10) Pub. No.: US 2017/0278072 A1
(43) Pub. Date: Sep. 28, 2017

(54) SYSTEM AND METHOD FOR RECOMMENDING A TASK TO USER USING ASSOCIATION PATTERN LEARNING

(71) Applicant: ELECTRONICS AND TELECOMMUNICATIONS RESEARCH INSTITUTE, Daejeon (KR)

(72) Inventors: Ki Sook CHUNG, Daejeon (KR); Chang Sup KEUM, Daejeon (KR)

(73) Assignee: ELECTRONICS AND TELECOMMUNICATIONS RESEARCH INSTITUTE, Daejeon (KR)

(21) Appl. No.: 15/400,245

(22) Filed: Jan. 6, 2017

(30) Foreign Application Priority Data
Mar. 24, 2016 (KR) 10-2016-0035340

(51) Int. Cl. G06Q 10/10; G06N 99/00

(52) U.S. Cl. CPC G06Q 10/1097; G06N 99/005

(57) ABSTRACT

Disclosed is a system for recommending a task, including: an log collecting unit collecting an action log of a user; a context information collecting unit collecting a schedule of the user; an association pattern learning unit generating an association pattern from the association relationship, when an occurrence probability of an association relationship between the action log and the schedule is equal to or higher than a predetermined reference value; and a recommended task generating unit generating a recommended task according to the schedule of the user by matching the schedule of the user with the association pattern.

### CROSS-REFERENCE TO RELATED APPLICATIONS

This application claims priority to and the benefit of Korean Patent Application No. 10-2016-0035340 filed in the Korean Intellectual Property Office on Mar. 24, 2016, the entire contents of which are incorporated herein by reference.

### TECHNICAL FIELD

The present invention relates to a system and a method for recommending a task to a user using association pattern learning.

### BACKGROUND ART

Every day lives of people are achieved while reacting with repeated life patterns weekly, monthly, and yearly or an affair which occurs occasionally. When the life pattern is described in detail, it can be seen that an association relationship between a pattern and a pattern and between the pattern and a schedule, in particular, an association relationship having an order exists.

An event which occurs next to one action influences an action which occurs next or the action which occurs next influences the event which occurs next to one action inversely thereto, and as a result, the event occurs during a certain period. In addition, it can be seen that the action occurs with the association even by various surrounding environments, that is, a season, a date, weather, and the like.

At present, the existing schedule management applications through a smart phone provide only announcement function for schedules set by users,

Therefore, development of an apparatus and a method which can provide the user specific customized task recommendation service by using the action of the user, and the like is required.

### SUMMARY OF THE INVENTION

The present invention has been made in an effort to provide an apparatus and a method for recommending a task to a user using an association relationship between an action and a schedule of the user to the user.

Meanwhile, technical objects desired to be achieved in the present invention are not limited to the aforementioned objects, and other technical objects not described above will be apparently appreciated by those skilled in the art from the disclosure of the present invention

An exemplary embodiment of the present invention provides a system for recommending a task, including: an log collecting unit collecting an action log of a user; a context information collecting unit collecting a schedule of the user; an association pattern learning unit generating an association pattern from the association relationship when an occurrence probability of an association relationship between the action log and the schedule is equal to or higher than a predetermined reference value; and a recommended task generating unit generating a recommended task according to the schedule of the user by matching the schedule of the user with the association pattern.

The log collecting unit may collect the action log every predetermined period.

The action log may include at least one of a call log, a payment log, a locational log, an application use log, and a media use log.

The system may further include a log storing unit storing the action log.

The context information collecting unit may further collect at least one of temporal information and environmental information when the action log collection occurs.

The temporal information may include at least one of a season, a day of a week, and a date.

The environmental information may include at least one of a location of a user, weather, and a temperature.

The association pattern learning unit may generate the association pattern by analyzing a sequence relationship between the action log and the schedule.

The association pattern learning unit may make time difference information between an occurrence time of the action log and the schedule be included in the association pattern.

The system may further include an association pattern storing unit storing the association pattern, wherein the association pattern learning unit may delete the stored association pattern when the occurrence probability of the association relationship is less than the predetermined reference value and the association pattern generated from the association relationship is stored in the association pattern storing unit.

The recommended task generating unit may generate the recommended task by using the association pattern stored in the association pattern storing unit.

The system may further include a recommended task announcing unit announcing the generated recommended task to the user through the terminal.

Another exemplary embodiment of the present invention provides a method for recommending a task, including: collecting an action log and a schedule of a user from a terminal of the user; deriving an association relationship between the action log and the schedule; determining whether an occurrence probability of the association relationship is equal to or higher than a predetermined reference value; generating an association pattern from the association relationship when the occurrence probability is equal to or higher than the reference value; and generating a recommended task according to the schedule of the user by matching the schedule of the user with the association pattern.

In the collecting of the action log and the schedule of the user, at least one of temporal information and environmental information when the action log collection occurs may be further collected.

In the generating of the association pattern, the association pattern may be generated by analyzing a sequence relationship between the action log and the schedule.

In the generating of the association pattern, time difference information between an occurrence time of the action log and the schedule may be included in the association pattern.

The method may further include storing the association pattern in an association pattern storing unit, wherein the storing of the association pattern in the association pattern storing unit may be performed after the generating of the association pattern.

The method may further include deleting the stored association pattern, wherein the deleting of the association pattern may be performed, after the determining whether the occurrence probability of the association relationship is equal to or higher than the predetermined reference value, when the occurrence probability of the association relationship is less than the reference value and the association pattern generated from the association relationship is stored in the association pattern storing unit.

In the generating of the recommended task, the recommended task may be generated by using the association pattern stored in the association pattern storing unit.

The method may further include announcing the generated recommended task to the user through the terminal.

According to exemplary embodiments of the present invention, an apparatus and a method for recommending a task to a user using an association relationship between an action and a schedule of the user can be provided to the user.

Meanwhile, effects which can be obtained in the present invention are not limited to the aforementioned effects and other unmentioned effects will be clearly understood by those skilled in the art from the following description.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

The accompanying drawings of this specification exemplify a preferred exemplary embodiment of the present invention and play a role of more clearly understanding the spirit of the present invention together with the following detailed description taken in conjunction with the accompanying drawings and thus it should not be understood that the present invention is not limited to only contents illustrated in the accompanying drawings.

FIG. 1 is a diagram for describing an association relationship between a user action log and a schedule.

FIG. 2 is a diagram for describing a leading pattern and a trailing pattern.

FIG. 3 is a block diagram of a system for recommending a task according to an exemplary embodiment of the present invention.

FIG. 4 is a diagram illustrating an association relationship and an occurrence probability according to an exemplary embodiment of the present invention.

FIG. 5 is a flowchart of a method for recommending a task according to an exemplary embodiment of the present invention.

FIG. 6 is a block diagram of a computing system executing a method for recommending a task according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish an element from another element, but nature or an order of the element is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

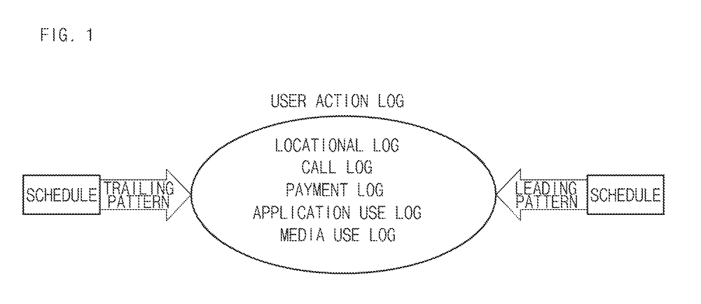

An association pattern will be described with reference to FIG. 1 prior to describing a system for recommending a task according to the present invention.

FIG. 1 is a diagram for describing an association relationship between a user action log and a schedule.

The user action log includes a locational log, a call log, a payment log, an application use log, and a media use log and means a record of an action performed by a user through a terminal of the user as illustrated in FIG. 1.

The locational log as an action log for locational information of the user may correspond to a location (a latitude, a longitude, and an altitude) of the user, a movement history of the user, a movement region of the user, and the like and the call log as an action log which may be extracted from a call history of the user may correspond to a call receiver, a sending time, a receiving time, and the like.

The payment log as an action log associated with payment through the terminal may correspond to a payment history, a payment target, a payment time, and the like of the user, and the application use log may correspond to an log associated with app use, such as a type, a use time, and the like of an application used by the user.

Further, the media use log is an action log associated with an action for reproduction of music, a moving picture, and the like.

However, the action log is not limited to the example and may also include a record of an action performed by the user through the terminal and a log generated from the locational information obtained by the terminal through moving while the user possesses the terminal.

The schedule means a schedule input in the terminal of the user.

In the present invention, the association pattern represents a pattern in which the action log of the user and the schedule input in the terminal are formed and the association pattern may be classified into a leading pattern and a trailing pattern.

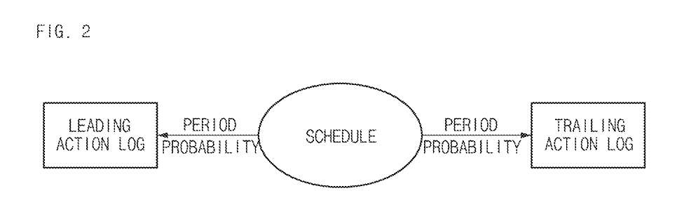

FIG. 2 is a diagram for describing a leading pattern and a trailing pattern and referring to FIG. 2, the leading pattern means a pattern in which as a schedule is generated, the log collection is performed earlier than the corresponding schedule and the trailing pattern means a pattern in which the log collection is performed later than the corresponding schedule as the schedule is generated.

In the association pattern, the schedule and the action log may have a certain time difference. For example, an association pattern which has a schedule such as an examination and in which the payment action to purchase a workbook before 30 days occurs has a time difference of 30 days.

In addition, a probability that the association pattern will be generated may vary for each association pattern. For example, an association pattern in which an action log to move to a pharmacy occurs with a probability of 80% after the schedule such as medical examination has an occurrence probability of 80%.

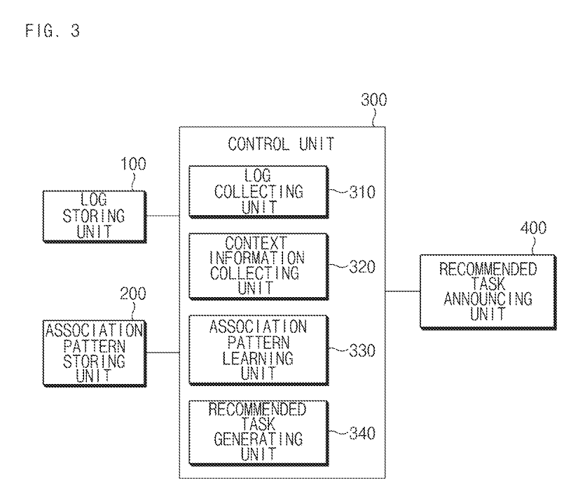

Hereinafter, a system for recommending a task according to the present invention will be described with reference to FIG. 3.

FIG. 3 is a block diagram of a system for recommending a task according to an exemplary embodiment of the present invention.

The system for recommending a task according to the present invention may include an log storing unit 100, an association pattern storing unit 200, a control unit 300, and a recommended task announcing unit 400.

However, since components illustrated in FIG. 3 are not required, the task recommending system having more components there than or less components there than may be implemented.

The log storing unit 100 is a component that stores the user action log collected by an log collecting unit 310 to be described below. The action log stored by the log storing unit 100 may be used when an association pattern learning unit to be described below generates the association pattern.

The association pattern storing unit 200 is a component that stores the association pattern generated by the association pattern learning unit to be described below. The association pattern stored by the association pattern storing unit 200 may be deleted by the association pattern learning unit under a specific condition and detailed contents thereof will be described below.

The control unit 300 as a component that performs an overall operation of the task recommending system may include an log collecting unit 310, a context information collecting unit 320, an association pattern generating unit 330, and a recommended task generating unit 340.

The log collecting unit 310 is a component that collects the user action log from the terminal of the user.

The log collecting unit 310 may collect the action log every certain period and the action log collected by the log collecting unit 310 may include a call log, a payment log, a locational log, an application use log, and a media use log as described above.

The context information collecting unit 320 is a component that collects the schedule of the user, and temporal information and environmental information when the action log occurs from the terminal of the user. The context which the context information collecting unit 320 collects include the schedule of the user, the temporal information and the environmental information.

For example, the context information collecting unit 320 may collect the schedule of the user from a calendar application of a smart phone which is the terminal of the user and collect a season, a day of a week, and a date as the temporal information. Further, the context information collecting unit 320 may collect a location of the user from a global positioning system (GPS) of the smart phone and weather and a temperature from a weather application as the environmental information.

Herein, each of the schedule, the temporal information, and the environmental information as the same class may establish the association relationship with the action log. For example, an examination schedule as the schedule and the action log to purchase the workbook 30 days before an examination day as the action log of the examination schedule may establish the association relationship. In addition, Sunday as the temporal information and an action log to climb a mountain on Sunday as the action log may establish the association relationship. Further, hot weather as the environmental information and an action log to turn on an air conditioner as the action log may establish the association relationship.

The schedule, the temporal information, and the environmental information may establish the association relationship with the action log as a combination form. For example, a combination of Tuesday as the temporal information and an action log in which the user is located in a company as the environmental information may establish the association relationship with an action log in which the user goes to an educational institute 8 hours after the user is located in the company as the action log.

The association pattern learning unit 330 is a component that generates the association pattern from the association relationship between the collected action log and the schedule, the temporal information, and the environmental information.

The association pattern learning unit 330 may generate the association pattern by analyzing a sequence relationship between the action log and the schedule, the temporal information, or the environmental information. For example, the association relationship between the examination schedule and the action log to purchase the workbook 30 days before the examination schedule is a relationship in which the action log precedes the schedule. Further, the medical examination schedule and a pharmacy visitation log 1 hour after the medical examination have a relationship in which the action log lags behind the schedule.

When a predetermined schedule exists, occurrence of an association relationship in which a specific action log is performed may be expressed as a probability and the association pattern learning unit 330 may generate the association pattern when the occurrence probability of the association relationship is equal to or more than a predetermined reference value.

For example, when 10 exercise schedules exist and thereafter, an action log to purchase drinking water occurs 7 times, an occurrence probability of an association relationship in which the drinking water is purchased according to the exercise schedule becomes 70%.

If the reference value for generating the association pattern is 60%, the drinking water purchase log after the exercise schedule will be generated as the association pattern in the above example and if the reference value is 80%, the drinking water purchase log will not be generated as the association pattern.

The association pattern learning unit 330 may make time difference information between the action log occurrence time and the schedule be included in the association pattern. When the association pattern in which the drinking water purchase log occurs 1 hour after the exercise schedule is generated in the above example, information of ‘1 hour after’ the exercise schedule is included in the association pattern.

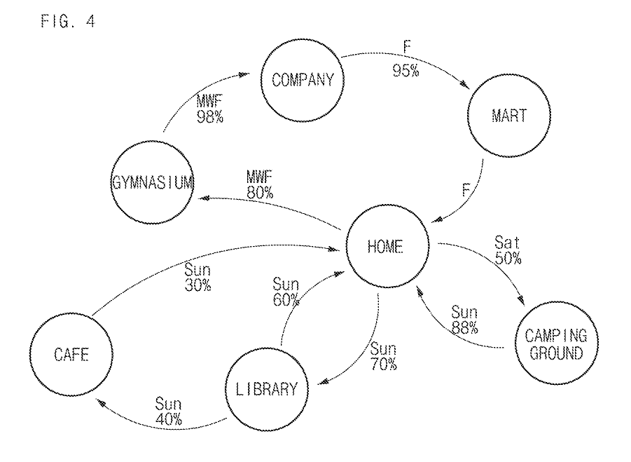

Hereinafter, the generation of the association pattern will be described with reference to an association relationship illustrated in FIG. 4.

FIG. 4 is a diagram illustrating an association relationship and an occurrence probability according to an exemplary embodiment of the present invention.

In FIG. 4, M means Monday, T means Tuesday, W means Wednesday, Th means Thursday, F means Friday, Sat means Saturday, and Sun means Sunday. Referring to FIG. 4, a first association relationship in which the user goes to a gymnasium when the user is located in a home (the environmental information) at Monday, Wednesday, and Friday (temporal information) exists with a the probability of 80%. Further, a second association relationship in which the user goes to the home when the user is located in a cafe (environmental information) on Sunday (temporal information) exists with a probability of 30%.

When the reference value is 70%, the association pattern learning unit 330 generates the first association relationship as the association pattern because the occurrence probability is higher than the reference value in the case of the first association pattern. On the contrary, since the occurrence probability is lower than the reference value in the case of the second association relationship, the association pattern learning unit 330 does not generate the second association relationship as the association pattern.

The association pattern generated by the association pattern learning unit 330 may be stored in the association pattern storing unit 200.

The association pattern learning unit 330 may generate the association pattern and delete the association pattern stored in the association pattern storing unit 200.

The association pattern learning unit 330 may delete the corresponding association pattern from the association pattern storing unit 200 when the occurrence probability of the association relationship of the association pattern stored in the association pattern storing unit 200 is less than the reference value.

For example, when an occurrence probability of the first association relationship is higher than the reference value, the association pattern is generated to be stored in the association pattern storing unit 200. However, since the log collecting unit 310 and the context information collecting unit 320 may continuously collect the action log and the context information, the occurrence probability of the first association relationship may vary as the time elapses.

When the occurrence probability of the first association relationship is lower than the reference value as the time elapses, since the association pattern according to the first association relationship is stored in the association pattern storing unit 200, the association pattern learning unit 330 deletes the association pattern stored in the association pattern storing unit 200.

The recommended task generating unit 340 is a component that generates a recommended task according to the schedule of the user by matching the schedule, the temporal information, or the environmental information of the user with the association pattern.

That is, when the first association pattern is generated by the first association relationship between a first schedule, temporal information, or environmental information and a first action log and the context information collecting unit 320 collects a second schedule which is the same contents as the first schedule, temporal information, or environmental information, the first action log is generated as the recommended task by matching the second schedule with the first schedule.

For example, when the association pattern by the association relationship between the ‘examination schedule’ (first schedule) and ‘purchasing the workbook’ 30 days before the examination (first action log) exists and the context information collecting unit 320 collects a schedule that ‘making an examination on April 20’ (second schedule), the recommended task generating unit 340 may generate ‘purchasing the workbook on March 20’ which is 30 days before April 20 as the recommended task by matching the second schedule with the first schedule.

The recommended task generating unit 340 may generate the recommended task by matching the temporal information or environmental information of the user with the association pattern in addition to the example.

According to the exemplary embodiment of the present invention, when the association pattern is stored in the association pattern storing unit 200, the recommended task generating unit 340 may generate the recommended task by using the stored association pattern. In addition, when the association pattern stored in the association pattern storing unit 200 is deleted as described above, the association pattern deleted is not used at the time of generating the recommended task by reflecting the deletion of the association pattern stored in the association pattern storing unit 200.

The recommended task announcing unit 400 as a component that announces the generated recommended task to the user through the terminal may correspond to an announcement function of a schedule management application, and the like.

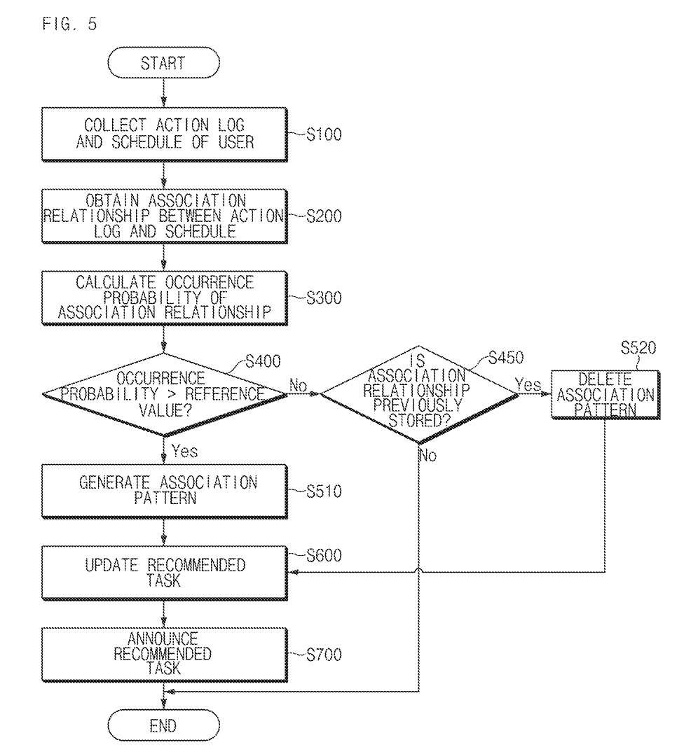

Hereinafter, a method for recommending a task based on the aforementioned components will be described in detail with reference to FIG. 5.

FIG. 5 is a flowchart of a method for recommending a task according to an exemplary embodiment of the present invention.

The log collecting unit 310 collects the action log of the user from the terminal of the user and the context information collecting unit 320 collects the schedule from the terminal of the user (S100).

As described above, the action log may include may include the call log, the payment log, the locational log, the application use log, and the media use log as described above.

The context information collecting unit 320 may collect even the temporal information and the environmental information when the action log occurs as well as the schedule.

The association pattern learning unit 330 obtains the association relationship between the collected action log and the schedule (S200).

In this step, the association relationship between the action log and the temporal information or environmental information as well as the schedule may be obtained. Further, as described above, the association relationship may be obtained by analyzing the sequence relationship between the action log and the schedule, temporal information, or environmental information.

The association pattern learning unit 330 calculates the occurrence probability of the association relationship (S300) and determines whether the occurrence probability is equal to or higher than a predetermined reference value (S400).

The association pattern learning unit 330 generates the association pattern from the association relationship when the occurrence probability is equal to or higher than the predetermined reference value (S510).

The association pattern learning unit 330 may make time difference information between the action log occurrence time and the schedule be included in the action log.

The association pattern learning unit 330 stores the generated association pattern in the association pattern storing unit 200 (S600).

According to the exemplary embodiment of the present invention, steps S100 to S600 may be periodically repeated and as the time elapses, a plurality of association patterns may be stored in the association pattern storing unit 200. Further, since the action log, and the schedule, the temporal information, and the environmental information are continuously collected as time elapsed, the occurrence probability of the association relationship may also vary.

Since the occurrence probability of the association relationship stored as the association pattern because the occurrence probability is equal to or higher than the reference value may also decrease to a value less than the reference value as the time elapses.

According to the exemplary embodiment of the present invention, in order to delete the association pattern, when the occurrence probability of the association relationship determined in step S400 is less than the predetermined value and the association pattern generated from the association relationship is the association pattern already stored in the association pattern storing unit 200, a step of deleting the association pattern stored in the association pattern storing unit 200 may be performed (S520).

The recommended task generating unit 340 updates the recommended task according to the schedule of the user by matching the schedule of the user with the association pattern generated by the association pattern learning unit 330 (S600).

The schedule of the user, and the temporal information or environmental information may become a matching target.

The recommended task generating unit 340 may update the recommended task by using the association pattern stored in the association pattern storing unit 200. When the recommended task is additionally stored or deleted in or from the association pattern storing unit 200, the recommended task may correspondingly additionally generated or deleted.

The recommended task announcing unit 400 announces the updated recommended task to the user through the terminal (S700).

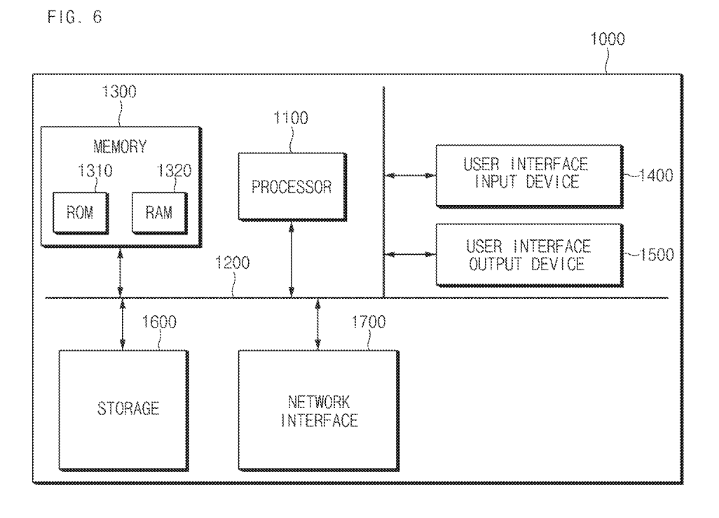

FIG. 6 is a block diagram of a computing system executing a method for recommending a task according to an exemplary embodiment of the present invention.

Referring to FIG. 6, the computing system 1000 may include at least one processor 1100, a memory 1300, a user interface input device 1400, a user interface output device 1500, a storage 1600, and a network interface 1700 connected through a bus 1200.

The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

In the system and method for recommending the schedule described as above, the constitutions and methods of the described exemplary embodiments cannot be limitatively applied, but all or some of the respective exemplary embodiments may be selectively combined and configured so that various modifications of the exemplary embodiments can be made.

In the aforementioned present invention, work or task which needs to be timely performed is recommended by finding or probabilistically learning the association relationship which exists between the action log and the context information, thereby helping the user to manage the time.

What is claimed is:

1. A system for recommending a task, the system comprising:
an log collecting unit collecting an action log of a user;
a context information collecting unit collecting a schedule of the user;
an association pattern learning unit generating, when an occurrence probability of an association relationship between the action log and the schedule is equal to or higher than a predetermined reference value, an association pattern from the association relationship; and
a recommended task generating unit generating a recommended task according to the schedule of the user by matching the schedule of the user with the association pattern.

2. The system of claim 1, wherein the log collecting unit collects the action log every predetermined period.

3. The system of claim 1, wherein the action log includes at least one of a call log, a payment log, a locational log, an application use log, and a media use log.

4. The system of claim 1, further comprising:
an log storing unit storing the action log.

5. The system of claim 1, wherein the context information collecting unit further collects at least one of temporal information and environmental information when the action log occurs.

6. The system of claim 5, wherein the temporal information includes at least one of a season, a day of a week, and a date.

7. The system of claim 5, wherein the environmental information includes at least one of a location of a user, weather, and a temperature.

8. The system of claim 1, wherein the association pattern learning unit generates the association pattern by analyzing a sequence relationship between the action log and the schedule.

9. The system of claim 1, wherein the association pattern learning unit makes time difference information between an occurrence time of the action log and the schedule be included in the association pattern.

10. The system of claim 1, further comprising:
an association pattern storing unit storing the association pattern,
wherein the association pattern learning unit deletes the stored association pattern
when the occurrence probability of the association relationship is less than the predetermined reference value and
the association pattern generated from the association relationship is stored in the association pattern storing unit.

11. The system of claim 10, wherein the recommended task generating unit generates the recommended task by using the association pattern stored in the association pattern storing unit.

12. The system of claim 1, further comprising:
a recommended task announcing unit announcing the generated recommended task to the user through the terminal.

13. A method for recommending a task, the method comprising:
collecting an action log and a schedule of a user from a terminal of the user;
deriving an association relationship between the action log and the schedule;
determining whether an occurrence probability of the association relationship is equal to or higher than a predetermined reference value;
generating an association pattern from the association relationship when the occurrence probability is equal to or higher than the reference value; and
generating a recommended task according to the schedule of the user by matching the schedule of the user with the association pattern.

14. The method of claim 13, wherein in the collecting of the action log and the schedule of the user, at least one of temporal information and environmental information when the action log occurs is further collected.

15. The method of claim 13, wherein in the generating of the association pattern, the association pattern is generated by analyzing a sequence relationship between the action log and the schedule.

16. The method of claim 13, wherein in the generating of the association pattern, time difference information between an occurrence time of the action log and the schedule is included in the association pattern.

17. The method of claim 13, further comprising:
storing the association pattern in an association pattern storing unit,
wherein the storing of the association pattern in the association pattern storing unit is performed after the generating of the association pattern.

18. The method of claim 17, further comprising:
deleting the stored association pattern,
wherein the deleting of the association pattern is performed,
after the determining whether the occurrence probability of the association relationship is equal to or higher than the predetermined reference value,
when the occurrence probability of the association relationship is less than the reference value and
the association pattern generated from the association relationship is stored in the association pattern storing unit.

19. The method of claim 13, wherein in the generating of the recommended task, the recommended task is generated by using the association pattern stored in the association pattern storing unit.

20. The method of claim 13, further comprising:
announcing the generated recommended task to the user through the terminal.
